(19) United States
(12) Patent Application Publication
(10) Pub. No.: US 2016/0057968 A1
(43) Pub. Date: Mar. 3, 2016

(54) Restrainable Pet Transporter

(71) Applicant: Karen Chandler, Venice, FL (US)

(72) Inventor: Karen Chandler, Venice, FL (US)

(73) Assignee: NAKED EYE IMAGES, INC., Venice, FL (US)

(21) Appl. No.: 14/831,311

(22) Filed: Aug. 20, 2015

Related U.S. Application Data
(60) Provisional application No. 62/041,710, filed on Aug. 26, 2014.

(51) Int. Cl. A01K 1/02; A01K 1/01

(52) U.S. Cl. CPC A01K 1/0272; A01K 1/0245; A01K 1/0107

(57) ABSTRACT

A versatile pet transporter can be wheeled, carried by hand, or restrained on a car seat. The handle for wheeling is telescopic, retractable, and recessed when not in use, obviating any danger from the handle in a car. Seat belts pass through six different flanges, anchoring the transporter to a car seat in all directions. The transporter may be fitted with a litter box and readily replaceable litter packages, a fan, sound monitoring, and other features.

### RELATED APPLICATION

This application claims the full benefit of Provisional Application 62/041,710 filed Aug. 26, 2014, which is incorporated herein in its entirety.

### TECHNICAL FIELD

A versatile pet transporter can be wheeled, carried by hand, or restrained on a car seat. The handle for wheeling is telescopic, retractable, and recessed when not in use, obviating any danger from the handle in a car. Seat belts pass through six different flanges, anchoring the transporter to a car seat in all directions. The transporter may be fitted with a litter box and readily replaceable litter packages, a fan, sound monitoring, and other features.

### BACKGROUND OF THE INVENTION

Pet carriers in the past have been designed with a handle for carrying, a handle for pulling, or with receptacles for automobile seat belts. Versatility and convenience are missing from the carriers of the past, along with a degree of safety which should be present when traveling in an automobile. The inertia of sudden stops and accidents in automobiles can cause a pet carrier on a seat to project forcefully toward other occupants of the automobile, causing great injury. While attempts have been made in the past to restrain pet carriers with automobile seat belts, they generally have not been effective to restrain the carriers' movement in all directions. Some carriers also include projections such as handles that can cause injury by striking people in a car.

When considering the construction and placement of a pull handle for a pet transporter (traveler or carrier), it should be observed that the overall design should not resemble a commonplace piece of luggage tilted on two wheels, having a recessed handle capable of only one position rigidly aligned with a base of the luggage. The pet transporter should be maintained in a substantially horizontal orientation while the pet is in it, and while it is pulled on a floor. A deficiency in the prior art has been in providing a pull handle which not only permits a horizontal orientation facilitated by four wheels, but does so with ease, and which also can be effectively stowed when not in use, as when the transporter (traveler or carrier) is strapped onto a vehicle seat.

The art has not provided a comprehensive design that permits convenient pulling as well as safe stowing on a car seat while also providing for ease of replacing litter and minimizing stress on both the pet and the pet's owner.

### SUMMARY OF THE INVENTION

My pet carrier includes a telescopic pull handle, wheels for pulling in a substantially horizontal orientation, and a six-point restraining system. It is easily opened to place the pet in it, and to accommodate a litter box with replaceable litter packages. In one embodiment, it includes a fan to assure the pet will not become overheated.

My invention also contemplates a snap-in electronic center, or “hub,” which includes a thermometer, a video camera for viewing the pet within, a speaker for providing music or the owner's voice to the pet, a microphone to enable listening to the pet, the thermometer, camera, speakers and microphone all enabled by an appropriate wireless system such as Bluetooth®, and a small internal light which can be operated remotely.

### BRIEF DESCRIPTION OF THE DRAWINGS

FIG. 1 is a perspective view of the pet carrier.

FIG. 2 is an exploded view of the carrier.

FIG. 3 shows the carrier on a car seat.

FIG. 4a illustrates a version of the structural framework and FIG. 4b is a perspective view of a covering which fits over the framework of FIG. 4a.

FIG. 5 is an exploded view of the framework of FIG. 4a.

FIG. 6 shows the assembled framework and covering of FIGS. 4a, 4b and 5.

In FIG. 7, the variation of FIGS. 4 to 6 is shown strapped to a vehicle seat.

FIG. 8 shows the assembly and installation of the litter box.

### DETAILED DESCRIPTION OF THE INVENTION

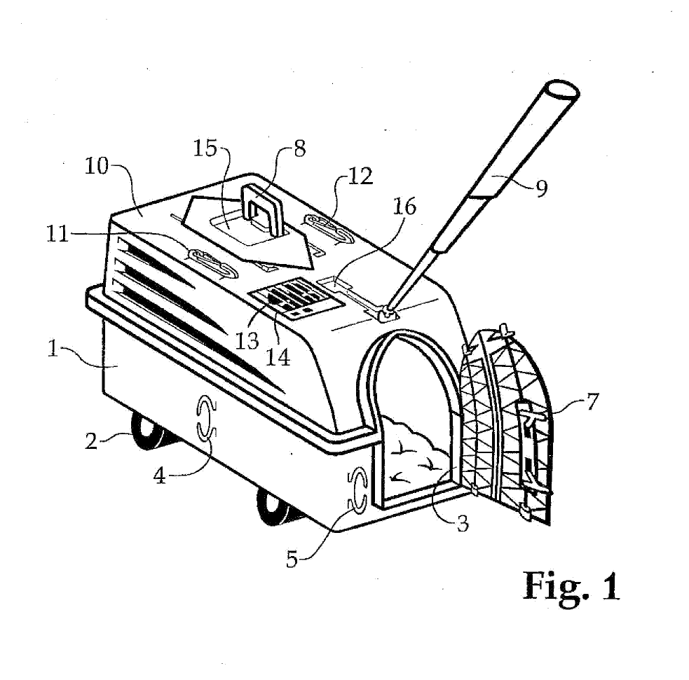

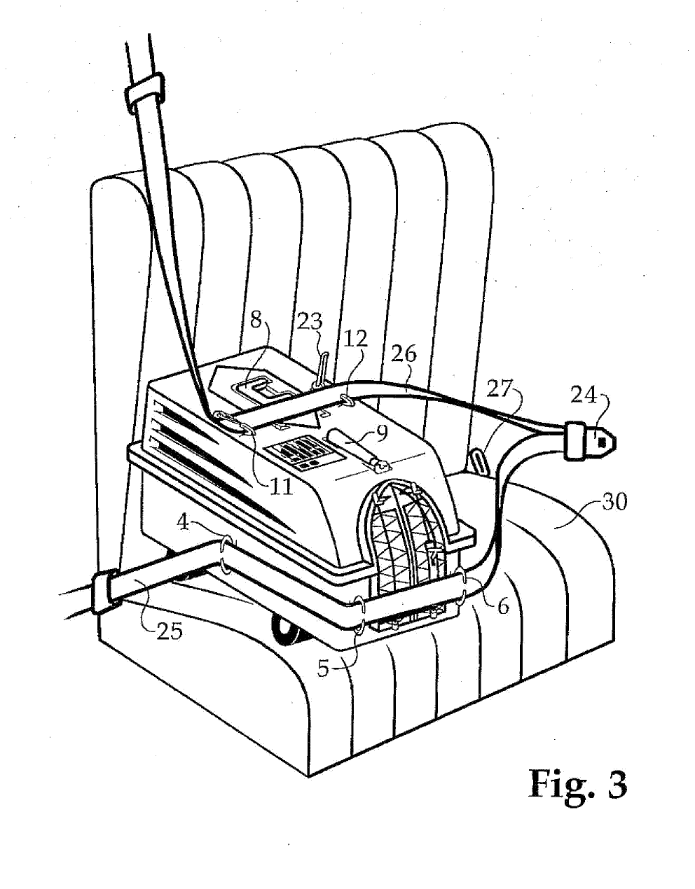

The invention will be described first with reference to FIG. 1. The carrier comprises a chassis 1 having four wheels 2 and a front opening 3. Visible on the chassis 1 are C-slots 4 and 5 for receiving a seat belt; C-slot 4 is on the side of chassis 1 and C-slot 5 is on the front of chassis 1. An additional C-slot is fixed to the side of chassis 1 opposite C-slot 4, and another C-slot 6, also not visible in this view, is fixed to the front of chassis 1 opposite C-slot 5, as will be seen in FIG. 3. Door 7 is hinged to front opening 3. Generally U-shaped handle 8 has been pivoted to an upright position for carrying by hand. Telescopic handle 9 is extended to show that it can be used for pulling the carrier on wheels 2. Handle 8 and telescopic handle 9 are fixed to carrier top 10, which has fixed to it C-clamps 11 and 12, seen in use in FIG. 3. A fan 13 can be seen through vent 14; the fan is operated by a battery not shown. Recessed areas 15 and 16 are provided for stowing handle 8 and telescopic handle 9.

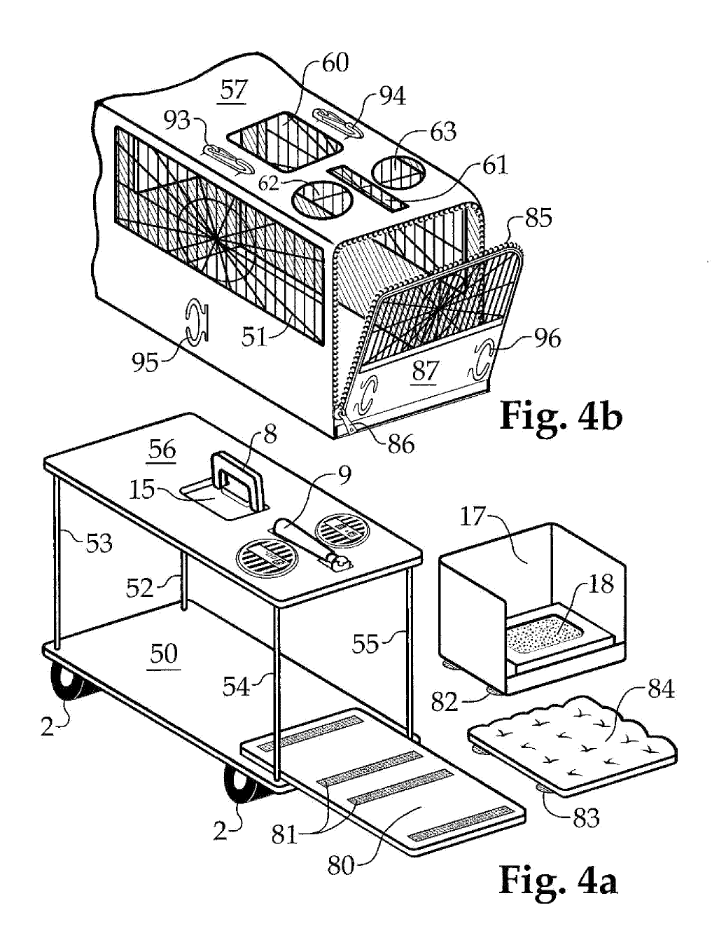

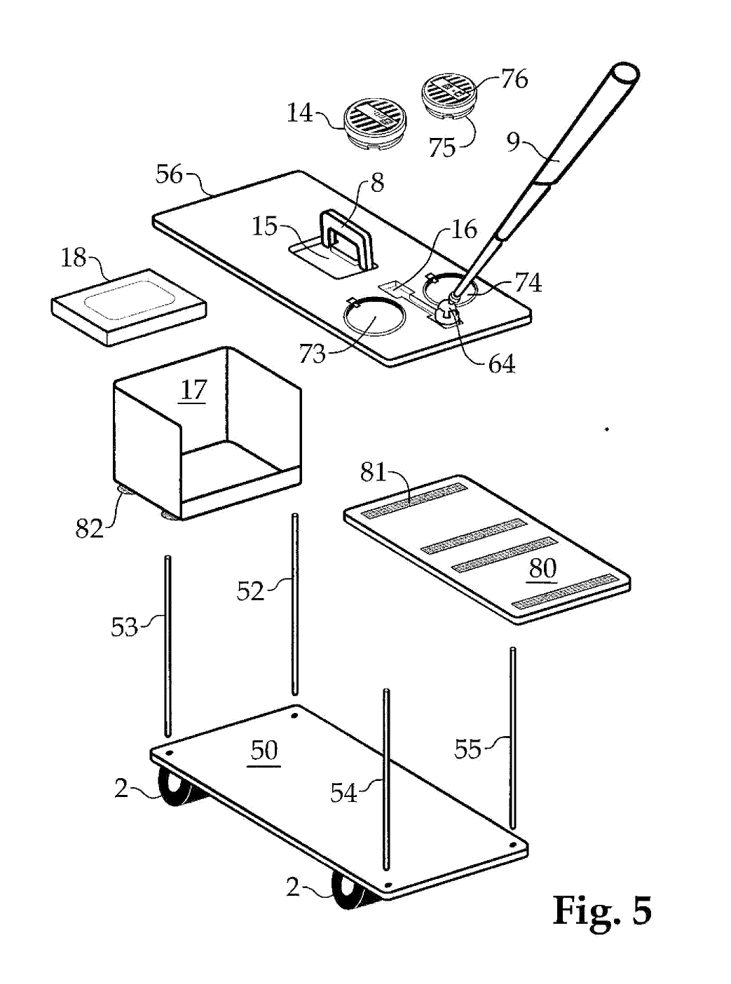

The electronic hub including a thermometer, a video camera for viewing the pet within, a speaker for providing music or the owner's voice to the pet, a microphone to enable listening to the pet, all enabled by an appropriate wireless system such as Bluetooth®, and a small light which may be operated remotely or manually by a switch, can be installed in any convenient location on the carrier top 10 or the chassis 1. The ability to hear and see the pet at all times, to communicate to it within the carrier, and to monitor the temperature to assist in regulating the fan, greatly enhances the versatility of the carrier. The speed of the fan may be regulated remotely by the owner or a simple on-off device may be operated automatically in response to a preset temperature. The enclosure, preferably the carrier top, may be made with an opening (see FIGS. 4a, 4b and 5) conforming to the size and shape of the electronic hub. If the customer opts not to include the electronic hub, a simple snap-in plate occupies the opening; if the hub is chosen as an option, it will be snapped in so the thermometer, light and camera are oriented toward the interior of the carrier.

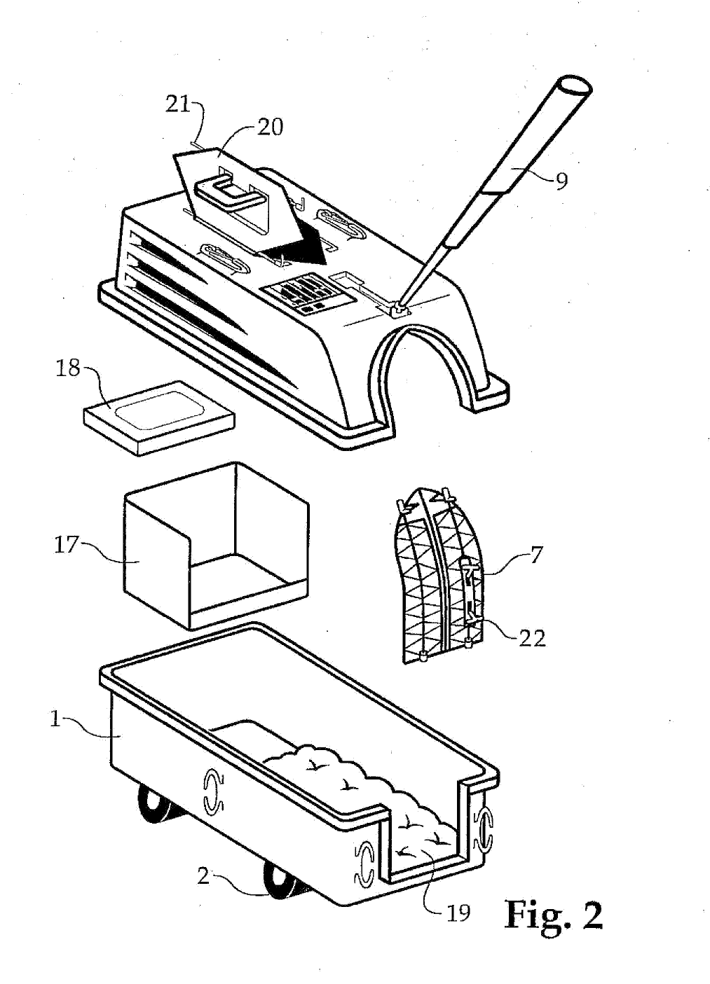

Referring now to FIG. 2, the chassis 1 is seen to accommodate a litter box 17 including a removable litter container 18. A padded floor 19 occupies the front area of the chassis 1. The litter container 18 may be in the form of an easily opened package. The padded floor 19 and the litter box 17 itself may snap in to the chassis 1, facilitating cleaning and replacing litter. Padded wall coverings may also snap in for easy removal and cleaning. In addition to door 7, access to the carrier can be had through hinged lid 20, normally secured by pins 21. Door 7 is seen to have latching devices 22. p The litter container 18 is seen to be designed specifically to fit into the litter box, and accordingly can be replaced with similar litter containers.

In FIG. 3, the carrier is shown on an automobile seat 30, ready for complete securing. The lower belt 25 has been passed through C-slots 4, 5, and 6, and the upper belt 26 has been passed through C-clamp 11, which is shown in the closed position, and C-clamp 12, shown still open. C-clamp 12 will be secured by lowering the snap extension 23. Lower belt 25 will be passed through the C-slot opposite C-slot 4, on the right side (as depicted) of chassis 1. The tongue 24 of the seat belts is to be inserted into belt fixture 27 in the conventional manner. The carrier will thus be secured by seat belts passing through four C-slots and two C-clamps.

The reader will readily see that my pet carrier is quite versatile in that it may be carried by hand, pulled on its wheels, or secured in an automobile seat, all with great convenience and ease.

The top handle 8 for carrying by hand is recessed when not in use (see FIG. 3), removing it as a possibly dangerous projection if the carrier is involved in an accident in a car.

The telescopic handle 9 for pulling the carrier as a cart not only is greatly reduced in size by the telescopic feature, but also is stowed (FIG. 3), in recess 16 (FIG. 1), in the top of the carrier, again eliminating a potential danger. The telescopic handle is long enough so that one may pull the carrier comfortably; the four wheels ensure that the carrier is horizontal to reduce stress on the pet inside the carrier, who will not be tipped as in a two-wheeled traveling case; also if there is cat litter in the carrier, it will not be spilled. One or more wheels may include a push-button brake (not shown) to further steady the carrier on a car seat or elsewhere.

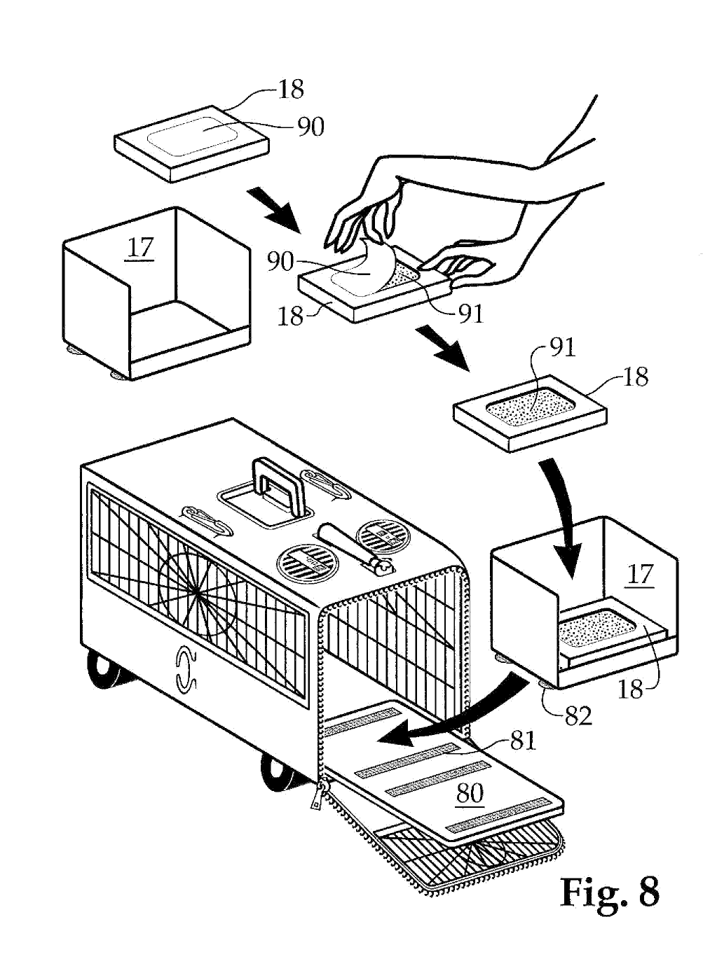

Referring now to FIGS. 4a and 4b, the illustrated variation of the invention differs in design from the design of FIGS. 1-3 partly in that it comprises a framework as in FIG. 4a and a flexible covering as shown in FIG. 4b, which is permanently affixed to the framework. The basic rigid parts of FIG. 4a are the bottom 50 to which the wheels 2 are attached, corner uprights 52, 53, 54 and 55, and top 56. Top 56 is similar to the substantially planar upper portion of top 10 of FIG. 1, accommodating carrying handle 8 and its stowing recess 15, and telescoping pull handle 9, shown nested and stowed in FIG. 4a. FIG. 4a also shows partially removed panel 80 which normally rests on bottom 50 and extends to the far rear of bottom 50. Panel 80 has Velcro® strips 81 on it for fastening to Velcro strips 82 on the underside of litter box 17 and Velcro strips 83 on the underside of cushion 84. Thus, the litter box 17 can be easily placed in the carrier by adhering it to panel 80 and sliding panel 80, along with cushion 84, to the far rear of the carrier (see also FIG. 8). As illustrated in FIG. 4a, litter box 17 contains a litter package 18. Preparation and placement of litter package 18 is illustrated in more detail in FIG. 8.

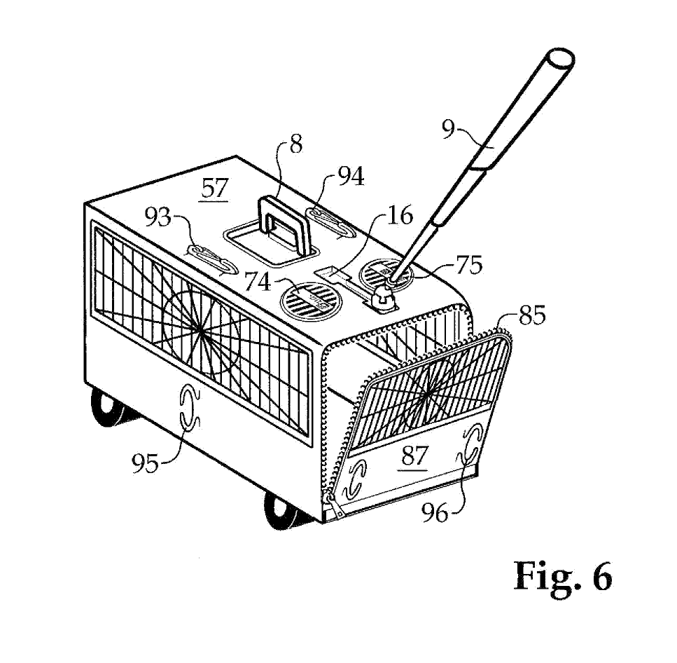

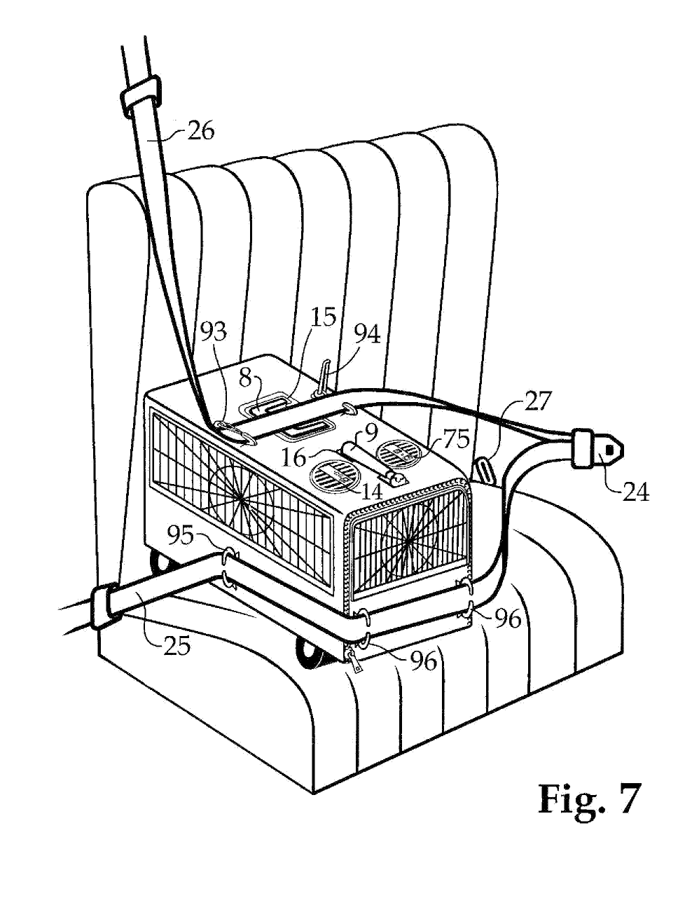

The covering 57 shown in FIG. 4b has opening 60 for carrier handle 8, opening 61 for telescoping pull handle 9, opening 62 for fan 13 and its vent 14 (see FIGS. 5 and 6), and opening 63 for the optional electronic center (see FIGS. 5 and 6). The front door 87 in the version of FIGS. 4a and 4b is opened and closed by a zipper 85 in flexible covering 57. Zipper handle 86 is shown at the lower end of zipper 85; a similar handle 86 may also have been moved to the lower end of the zipper track obscured by door 87. Note that the zipper 85 terminates before completely releasing door 87; door 87 is therefore in the form of a flap. C-slots 96 are sewn or riveted to door 87. C-clamps 93 and 94 are sewn, riveted, or otherwise attached to covering 57; they may be approximately in the positions of C-slots 11 and 12 of FIG. 1 after covering 57 is placed over top 56. C-slot 95 is also sewn, riveted or otherwise fastened on the side of covering 57; a similar one may be secured to the obscured side of covering 57. The sides of covering 57 may include mesh-like portions 51 to provide two-way visibility. Covering 57 may be permanently fastened or adhered to the framework of FIG. 4a in any convenient manner.

In FIG. 5, parts of the assembled FIG. 4a are shown in exploded form. Bottom 50 is supported on four wheels 2. Uprights 52, 53, 54 and 55 will be secured on bottom 50. Panel 80 will rest on bottom 50, and can slide on bottom 50. Panel 80 has Velcro® strips 81 on it so that litter box 17, having complementary Velcro strips 82 on its underside, can be temporarily secured to it. Velcro strips 81 may also temporarily secure a cushion such as padded cushion 84 (see FIG. 4a), having complementary Velcro strips 83 on its underside. Litter package 18 is sized to fit in the litter box 17, is readily inserted and removable (see FIG. 8), but also can be stabilized with Velcro or any other convenient device or system. Rigid top 56 includes an opening 73 to receive a fan and its vent 14; the opening 73 may be threaded or otherwise constructed to permit easy insertion of the fan with a small motor and battery, not shown. Top 56 may include also a second opening 74 for a second insert 75 including additional features activated by switch 76. The additional features are described below. Telescoping handle 9 is extended in this view; when nested, it fits in recess 16. Carrying handle 8 is hinged to be placed in recess 15 when not in use.

FIG. 5 particularly shows the ball-and-socket joint 64 at the base of telescoping pull handle 9. The ball-and socket joint enables supple changes in direction with minimal stress on the pet inside the transporter. With the ball-and-socket joint 64, the pull handle is readily moved in any direction.

The transporter as described in FIGS. 4a, 4b, and 5 is shown assembled in FIG. 6, with the litter box omitted for the sake of simplicity. Covering 57 encloses the entire transporter. Door 87 is shown in the open position, the zipper 85 having been opened completely. Pull handle 9 is fully extended. Carrier handle 8 is also ready for use. The assembled transporter includes a battery-operated fan directly below vent 74, and an electronic control panel 75 in place, passing through opening 63 in covering 57 (see FIG. 4b) and opening 74 in top 56. C-slot 95 is fixed directly on the side of covering 57.

In FIG. 7, the version of FIGS. 4a, 4b, 5, and 6 is shown ready to be secured on a vehicle seat in a manner similar to FIG. 3. Lower seat belt 25 passes through C-slots 95, and 96, and will be passed through similar C-slot 95, not shown, on the opposite (obscured) side of the transporter. Upper seat belt 26 passes through C-clamp 93, already closed, and C-clamp 94, which will be closed when tongue 24 is inserted into belt fixture 27. Carrying handle 8 is stowed in its recess 15, and telescoping pull handle 9 is nested and stowed in its recess 16. This unit is equipped with both a fan, directly below vent 14, and an electronic control panel 75.

The electronic control panel 75 may provide for any one or more of (a) a thermometer, which may provide a digital readout to the owner, (b) a camera such as a small video camera for transmitting images from inside the transporter to the owner, (c) small lights, such as LED or other “cool” lights, (d) a microphone for wirelessly transmitting sound to the owner, (e) one or more small speakers so the owner may wirelessly transmit voice or music to the interior, (f) remotely operated speed control for the fan.

The described six-point belt guides—four C-slots and two C-clamps—assure that the carrier will remain in place during sudden stops and even forceful accidents. Persons skilled in the art will recognize that the belt retaining function performed by the illustrated C-slots and C-clamps could as well be performed by various flanges, buckles, straps, cords, clamps, clasps, and the like. They may remain open, as in the case of the C-slots 4, 5, 6 95 and 96, or closed (closable), as in the case of the C-clamps 11, 12, 93 and 94. I do not intend to be limited to a particular type of retaining device and accordingly use the term “belt retainer” for any and all such devices. However, it should be noted that many, if not most, vehicle safety belts are attached permanently to the seats, typically both at seat level and at the upper back; the two belts converge to a single tongue which is inserted into a slot. Because the two belts converge to a single tongue, a single belt cannot pass through a retainer in the form of a closed loop. A belt can easily be placed in the depicted C-slots 4, 5, 6, 95 and 96 and will remain in place once the belt is secured. Likewise the open C-clamps 11, 12, 93 and 94 easily accommodate a belt and are readily closed and opened for securing the transporter onto a vehicle seat and removing it for further transporting. Deploying the six belt retainers as described has been found to provide excellent insurance against movement of the transporter in all directions.

The fan, the litter box, music, light and thermometer all help to reduce stress in the pet, also reducing anxiety of the owner.

FIG. 8 illustrates the convenient use of litter box 17. A litter package 18 sized to fit snugly in litter box 17 has a perforated removable cover 90. Removing the cover 90 exposes litter 91 having an area suitable for a pet. Using Velcro strips 82 and 81, the litter box is temporarily secured to the rear of panel 80 as indicated by the arrow, and panel 80 is slipped to the rear of bottom 50 (see FIG. 4a), leaving room for cushion 84, which may also be secured by adhering Velcro strips 81 to Velcro strips 83 (see FIG. 4a).

It is to be understood that, wherever Velcro strips are mentioned, other forms and shapes of Velcro® fasteners may be used; snaps and any other type of suitable fasteners may also be used.

1. A pet transporter comprising (a) a pet enclosure, said pet enclosure including a top, a bottom, and four wheels on said bottom, and (b) a telescoping handle, said telescoping handle including a pivot fixed at its base to said top.

2. The pet transporter of claim 1 wherein said pivot comprises a ball and socket joint.

3. The pet transporter of claim 1 including a recess on said top adapted to contain said telescoping handle when it is not extended.

4. The pet transporter of claim 1 including at least six belt retainers attached to said transporter, for securing said transporter with a seat belt to a vehicle seat.

5. The pet transporter of claim 1 wherein said pet enclosure includes two sides, a front and a back, and including seat belt retainers on said sides, said front, and said top.

6. The pet transporter of claim 5 including a door in said front, said door being secured by a zipper.

7. The pet transporter of claim 1 including a hinged carrying handle on said top and a recess in said top adapted to contain said carrying handle when not in use.

8. A pet transporter comprising an enclosure having a bottom, two sides, a top, and a front and including six belt retainers for receiving an automobile passenger seat belt, one of said belt retainers being fixed to each side of said pet transporter, two of said belt retainers being fixed to the front of said pet transporter, and two of said belt retainers being fixed to the top of said pet transporter.

9. The pet transporter of claim 8 wherein said belt retainers are selected from C-slots and C-clamps.

10. The pet transporter of claim 8 including four wheels fixed to said bottom of said transporter, and a telescopic pull handle adapted for pulling said pet transporter on said wheels, said pull handle being articulated on said top.

11. The pet transporter of claim 10 wherein said top has a recess adapted to retain said telescopic pull handle when it is closed.

12. The pet transporter of claim 10 wherein at least one of said wheels includes a hand-activated brake.

13. The pet transporter of claim 8 including (a) battery-powered fan inside said enclosure and (b) at least one cushion.

14. The pet transporter of claim 13 wherein the speed of said fan is adjustable.

15. The pet transporter of claim 8 including a removable litter box.

16. The pet transporter of claim 15 including litter in a prepackaged container adapted to fit in said litter box.

17. The pet transporter of claim 16 wherein said prepackaged container includes a readily removable cover of a size adequate to expose an area of litter suitable for a pet when said removable cover is removed.

18. The pet transporter of claim 8 including a handle for hand-carrying on said top of said transporter.

19. The pet transporter of claim 8 including a battery powered electrical system comprising at least one of (a) a light, (b) a microphone, (c) a speaker, (d) a camera, and (e) a temperature sensor.

20. A pet transporter comprising (a) a rigid framework, said rigid framework including a base having four wheels and a top, said top including a handle for hand carrying, a telescoping handle for pulling, and recesses for stowing each of said handles, (b) a flexible enclosure sized to fit over said rigid framework, said flexible enclosure including a door opened and closed by a zipper, (c) a rigid panel resting on said base, said rigid panel being slidably removable from said pet transporter through said door, (d) a litter box on said rigid panel, and (e) a package of litter in said litter box.
